(19) United States
(12) Patent Application Publication
(10) Pub. No.: US 2005/0203839 A1
(43) Pub. Date: Sep. 15, 2005

(54) Method for Transferring Mortgage Servicing Rights

(75) Inventors: Robert M. Dowell, Golden, CO (US); Michael P. Lau, Boulder, CO (US)

Correspondence Address: KENNETH C. WINTERTON;HOLLAND & HART LLP, P. O. BOX 8749, DENVER, CO, 80201-8749, US

(73) Assignee: Phoenix Analytic Services, Inc., Denver, CO (US)

(21) Appl. No.: 10/904,911

(22) Filed: Dec. 3, 2004

(51) Int. Cl. G06F 17/60

(52) U.S. Cl. 705/39

(57) ABSTRACT

Abstract of the Disclosure

A system and method is provided for marketing and selling mortgage servicing rights (MSR). The method includes setting a contract price for the sale of MSR that are to be originated in the future. A buyer and a seller enter into a purchase and sale agreement in which the buyer commits to purchase the MSR for loans to be originated in the future, and the seller agrees to sell the MSR on those loans at a fixed point in time (MSR sale date). The price for each MSR is determined at the time of the sale based upon an agreed to pricing grid that contains price adjustments for differences between loan interest rates and par interest rates on the MSR sale date.

### Detailed Description of the Invention

### FIELD OF THE INVENTION

The present invention is directed to marketing, sale and transfer of loan servicing rights, and more particularly, to the marketing, sale and transfer of mortgage loan servicing rights.

### BACKGROUND

Commercial, residential, and consumer loans account for a large portion of financial transactions. As is well known, a loan is a sum of money transferred to another for temporary use, to be repaid with or without interest according to terms of the loan agreement written in the accompanying bond, note, mortgage or other document of indebtedness. A loan may be taken for numerous purposes, and may be secured or unsecured. With a secured loan, a borrower pledges collateral that will be forfeited to the lender if the borrower fails to repay the loan. An unsecured loan is not backed by a pledge of assets. A common secured loan is referred to as a mortgage loan, which is secured by a home or other real property. The mortgage loan is secured by a mortgage or deed of trust that is recorded with an appropriate government office.

Mortgage loans are commonly made by mortgage lenders, such as local banks, national banks, and mortgage companies. The mortgage lender, in order to maintain liquidity and the ability to continue making loans, often sells a mortgage to another company, referred to as an investor, such as Fannie Mae, Freddie Mac, and Ginnie Mae or securitizes the loan with other mortgage loans into a Mortgage Backed Security (MBS). When selling the mortgage, the servicing of the mortgage may also be sold. Mortgage servicing is the activity of keeping a mortgage loan current, including, but not limited to, collecting monthly mortgage payments, forwarding principal and interest payments to the current mortgage holder (if the loan has been sold), maintaining escrow accounts, paying taxes and insurance premiums, taking steps to collect overdue payments, and when necessary, foreclose on a property. Mortgage servicing may be performed by the original lender, or the lender may sell the right to service a mortgage to another company, which performs the service for a fee that is imbedded in the interest rate on the loan. Some companies specialize in servicing mortgages, both their own and those made by other lenders. The original lender may sell mortgage servicing rights to one company and securitize the mortgage into a MBS.

Mortgage servicing rights are traditionally sold through either a bulk transaction or a flow transaction. A bulk transaction is when a company sells existing servicing rights where all of the underlying mortgage loan characteristics are known. Those characteristics include servicing fee, loan size, interest rate, taxes and insurance constant and geography. A flow transaction is when a company enters into a contract to sell its future servicing rights. None of the loan characteristics are known in a flow transaction. Instead, they are traditionally based upon the characteristics of the loans created over the previous few months.

### SUMMARY OF THE INVENTION

The present invention provides a system and method for marketing and selling mortgage servicing rights (MSR). The method includes setting a contract price for the sale of the MSR associated with mortgage loans that are to be originated in the future. A buyer and a seller enter into a purchase and sale agreement in which the buyer commits to purchase the MSR for mortgage loans to be originated in the future, and the seller agrees to sell the servicing rights on those loans at a fixed point in time. The price for each MSR is determined at the time of the sale based upon an agreed to pricing grid within the purchase and sale agreement that contains price adjustments for differences between the actual loan interest rates and par interest rates on the MSR sale date.

In one embodiment, the present invention provides a method for setting a price for at least one mortgage servicing right (MSR), comprising: (a) setting a contract price for at least one MSR associated with at least one mortgage loan, the at least one mortgage loan originated by a lender; (b) determining a par interest rate for a sale date on which the first MSR will be sold by the lender to a buyer of the first MSR; and (c) adjusting a price paid for the MSR by the buyer based on a difference between the loan interest rate and the par interest rate as of the MSR sale date. The setting step may comprise: (a) setting a price for each MSR to be sold; and (b) setting a price adjustment for a rate difference between the par interest rate and the loan interest rate. The determining step may comprise accessing a publicly available index of market interest rates on the MSR sale date. One publicly available index is MTGEFNCL, which is available daily on Bloomberg. The adjusting step may comprise: (a) calculating a difference between the loan interest rate and the par interest rate; and (b) adjusting the price based on a magnitude of the difference. The adjusting step comprises, in one embodiment: (a) calculating a difference between the loan interest rate and the par interest rate on the MSR sale date; (b) defining an index that established the par interest rate; and (c) determining a modified price based on the difference between the loan interest rate and the par interest rate on the MSR sale date.

In another embodiment, the invention provides a method for brokering the sale of mortgage servicing rights (MSR), comprising: (a) locating a seller desirous of selling of at least one MSR associated with a mortgage loan, wherein the mortgage loan will have a loan interest rate to be determined at a first date, will be funded at a second date, and will be securitized and sold at a third date, and wherein the MSR is sold at a fourth date; (b) locating a buyer desirous of buying at least one MSR; (c) negotiating a price for the MSR between the seller and buyer, wherein the price comprises a base price and an excess multiple; (d) setting a pricing grid for the base price, the pricing grid adjusting the base price and the excess multiple based on a difference between the loan interest rate and a par interest rate on the fourth date; and (e) determining a final price for the MSR based on the pricing grid. The method may further comprise: (f) receiving payment from the buyer based on the final price; and (g) receiving the MSR from said seller. The determining step, in one embodiment, comprises: (a) accessing a publicly available index to determine the par interest rate; (b) calculating a difference between the loan interest rate and the par interest rate; and (c) determining said final price based on the difference and the pricing grid. One publicly available index is MTGEFNCL, which is available daily on Bloomberg. The setting step may comprise: (a) defining an interest rate as par for comparison to the loan interest rate; and (b) determining a modified price based on a magnitude of the difference between the loan interest rate and the par interest rate on the fourth date.

In yet another embodiment, the invention provides a method for determining the price of a mortgage servicing right (MSR) to be sold from a seller to a buyer at a future MSR sale date, comprising: (a) setting a contract price for at least one MSR associated with at least one mortgage loan, the at least one mortgage loan to be originated by the seller at a future closing date and the at least one mortgage loan having an associated loan term and loan interest rate; and (b) setting a pricing grid for determining a final price for the at least one MSR based on the contract price and a difference between the loan interest rate and a par interest rate on the future MSR sale date. The setting of a contract price, in an embodiment, comprises: (a) analyzing a plurality of prior loans originated by the seller over a predetermined time period prior to the setting step; (b) accounting for future interest rate movements; and (c) setting the contract price based upon actual interest rates of the loans and the impact of future interest rate movements. The pricing grid may comprises: (a) a par interest rate on the future MSR sale date; and (b) a plurality of bands corresponding to a magnitude of the difference between the loan interest rate and the par interest rate on said future MSR sale date. The final price on the MSR sale date is greater than the contract price when the par interest rate is greater than said loan interest rate. The final price is less than the contract price when the par interest rate is less than the loan interest rate.

### BRIEF DESCRIPTION OF THE DRAWINGS

Fig. 1 is a diagram illustrating the timeline for a typical mortgage loan;

Fig. 2 is a graph illustrating interest rate fluctuations through a period of time;

Fig. 3 is a chart illustrating loan interest rates and loans present under the various interest rates through the time period of Fig. 2;

Fig. 4 is a flow chart diagram illustrating the operational steps for the sale of one or more MSR of an embodiment of the invention;

Fig. 5 is a flow chart diagram illustrating the operational steps for pricing an MSR for an embodiment of the invention;

Figs. 6A and 6B illustrate a daily lock chart of loans originated in an embodiment of the invention;

Figs. 7A through 7C are charts illustrating pricing grids and sale prices for MSR according to an embodiment of the invention; and

Figs. 8A and 8B are charts illustrating pricing grids of an embodiment of the invention.

### DETAILED DESCRIPTION

The present invention provides a method for marketing and selling mortgage servicing rights (MSR). The method includes setting a contract price for the sale of one or more MSR that are to be originated in the future. A buyer and a seller enter into a purchase and sale agreement in which the buyer commits to purchase the MSR for loans to be originated in the future, and the seller agrees to sell the servicing rights on those loans at a fixed point in time. The price for each MSR is determined at the time of the sale based upon an agreed to pricing grid that contains price adjustments for differences between loan interest rates and par interest rates on the date of the sale of the MSR. While the discussion herein is directed to mortgage loans, and servicing rights associated therewith, one of skill in the art will readily recognize that the principles described herein are also applicable to numerous other loan types, including both secured loans such as vehicle loans and unsecured loans such as student loans. The disclosure is not intended to be limited strictly to mortgage loans, and these loans are described for purposes of explanation.

At the outset, several key terms used at various times in this document are defined:

Agency – often the Investor and purchaser of originated loans. Typical agencies include Fannie Mae, Freddie Mac, Ginnie Mae, the Federal Home Loan Bank and private institutions.

Base Servicing Fee – The current required servicing fee level as required by the agencies. Currently for Fannie Mae and Freddie Mac fixed-rate loans the base service fee is 25 basis points.

Excess Servicing Fee – Any servicing fee created above and beyond the Base Servicing Fee.

Forward Bulk Sales Structure – MSR delivery method where loans are originated and pooled for a periodic sale to the MSR purchaser. The periods for the sale may be monthly, bi-monthly, quarterly, etc.

Flow Sale Servicing Transaction – Method of entering into MSR sales contracts (Purchase and Sale Agreements) for loans that have not been originated at the time of contract execution. A seller commits to sell MSR, on loans meeting certain characteristics, on a future MSR Sale Date.

Guarantor Fee – The amount paid to the Agency to insure the timely payment of principal and interest to the holders of the MBS. The Guarantor Fee is set forth in a contract that exists between the Originator of the loans and the issuing Investor.

Gross Servicing Fee – The difference between the stated investor yield and the loan's interest rate. The Gross Servicing Fee is composed of the Net Servicing Fee and the Guarantor Fee

Hedge – an instrument used to protect the financial risk associated with changes in value to the loan or Mortgage Servicing Right due to changes in interest rates.

Investor – The Investor is the party that purchases the underlying mortgage loans and guarantees the performance of the bond issued by the Originator in the secondary mortgage market. Typical Investors include Fannie Mae, Freddie Mac, Ginnie Mae, FHLB and private Investors.

Investor Yield (a.k.a. Investor Rate or Security Pass-Through Rate) –The stated rate passed through to MBS (bond) holders. This is the annualized return to bond Investors.

Loan Application Date – Date on which a borrower applies for a mortgage loan. Borrower completes the Agency uniform loan application 1003.

Loan Closing Date – Date on which an approved loan is officially funded and the mortgage is created, occurring after the Loan Application Date. The Originators source of funds typically comes from a line of credit, commonly referred to as a warehouse line of credit.

Loan Lock-In Date – The date that the interest rate on the mortgage is established. The rate is usually established at or near Par. Once the loan is locked-in, the Originator/lender is obligated to lend at the stated rate and terms. This may occur on the Loan Application Date, the Loan Closing Date or at some point in between these two dates.

Letter of Intent (LOI) – Contract between buyer and seller of MSR. Buyer enters into a commitment to purchase the MSR for loans to be originated in the future (flow contract). The seller agrees to sell the MSR on those loans at a fixed point in time. Under methods of selling MSR the terms and value of the contract are established within the LOI. There are numerous terms within the LOI. These include a purchase price percentage for the Base Servicing Fee and a multiple for the Excess Servicing Fee.

Mortgage Backed Security (MBS) – A security issued by an Originator as collateral for the underlying mortgage loans. MBS are typically guaranteed by an Agency.

Mortgage Servicing Rights (MSR) – The right to manage the servicing asset. This asset requires the holder to actively service the underlying mortgage loans. Responsibilities include collecting borrower payments, escrowing collected funds and remitting these funds to Investors or MBS holders, escrowing property taxes and property insurance funds and remitting these funds to the appropriate state or county government and insurance company.

MSR Sale Date – Typically last day of the month of the chosen delivery period. For instance a contract to deliver January, February and March loan originations which are securitized in April will typically have a MSR Sale Date of April 30.

Net Service Fee – Portion of the interest rate cash flow that the holder of the MSR is entitled to for managing the loans. The Net Service Fee equals the Gross Servicing Fee minus the Guarantor Fee.

Originator – the lending organization that initially lends to the mortgagor (borrower). Typically Originators sell the loan(s) and the mortgage servicing right(s) into the secondary market. The loan and mortgage servicing right(s) asset can be retained, sold together or sold separately.

Par (interest rates) – At a given point in time, the prevailing interest rate that is being originated by the primary mortgage market at large. One index which can be used to calculate Par is the MTGEFNCL index which is available on Bloomberg. Par has a margin of 50 basis points added to the index, which approximates the Net Servicing Fee and the Guarantor Fee.

Purchase and Sale Agreement – Establishes the instructions and guidelines for the MSR sale process. Also establishes the date that the right of ownership is physically transferred between the seller and buyer.

Security Issue Date – This represents the date that bundled loans are issued as a mortgage backed security (MBS). Typically, loans originated between the 1st of month 1 and the middle (15th) of month 2 will be securitized/issued between the 20th and 25th of month 2.

Security Settlement Date – The date established by the Bond Market Association on which newly issued securities formally settle.

Having set out these definitions, embodiments of the present invention are now described. Flow MSR sales include but are not limited to co-issue transactions and forward bulk transactions. Both of these transactions commonly have monthly sale dates that occur in the month that the mortgage security is created. The difference is that in a co-issue transaction the servicing rights are physically transferred to the buyer in the same month as the MSR Sale Date, while the forward bulk transfer is generally on a quarterly basis.

One component of traditional flow transactions that many potential buyers dislike is the fact that the MSR price is determined in advance of the MSR Sale Date regardless of what has happened to Par interest rates leading up to the actual MSR Sale Date. MSR values are greatly influenced by interest rates. When interest rates go up, MSR values go up, and when interest rates go down MSR values go down. The timeframe between the loan lock-in date and the MSR Sale Date of a flow transaction is generally between 30 and 90 days. If interest rates fall during this time period, the servicing value will also fall.

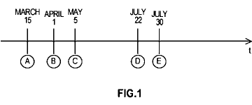

Referring to Fig. 1, a timeline of a single mortgage loan transaction is illustrated. While the concepts of this invention may be used on numerous loans and on bundles of loans, the illustration of a single loan is used for ease of understanding and discussion. It will be understood that these same principles apply regardless of the number of loans included in a transaction. In the example of Fig. 1, a mortgage lender (hereinafter 'lender') enters into a Purchase and Sale Agreement with an MSR buyer (hereinafter 'buyer') on March 15, referred to as point A in Fig. 1. The agreement includes a set price for the Base Servicing Fee and Excess Servicing Fee. The lender proceeds to lock-in an interest rate with a borrower on April 1, illustrated as point B in Fig. 1. The locked interest rate may be, for example, 6.0% on a 30 year conventional fixed rate mortgage. The mortgage closes on May 5, illustrated as point C. On July 22, the lender sells the mortgage to an Investor, as indicated at point D of Fig. 1. Finally, at point E, the lender sells the MSR associated with the loan to the buyer.

Due to fluctuations in interest rates, the Par interest rate for 30 year fixed conventional mortgages may drop, for example, to 5.5% on July 30. Due to this drop in interest rates, the likelihood that the borrower will re-finance the loan is increased, as the borrower may re-finance the loan at a lower interest rate and may save a significant amount of money. Due to the increased likelihood that a buyer will re-finance the loan, the present value of the MSR is reduced. The present value of the MSR is reduced because the increased likelihood that the borrower will re-finance, eliminating the buyer's monthly income stream from the MSR. Similarly, the Par interest rate for 30 year fixed conventional mortgages may rise, for example, to 6.5% on July 30. This rise in interest rates decreases the likelihood that a borrower will re-finance the loan, thus increasing the value of the MSR.

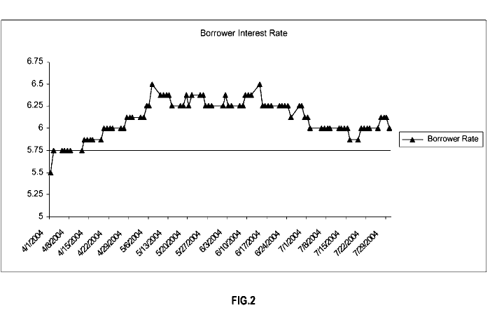

Having described the general timing for a single mortgage transaction, it will be understood that such transactions, for a single lender, generally occur many times throughout the course of a month, week, or even day. Over the course of time, a lender accumulates a portfolio of loans that were locked-in on different dates. Each of these loans is originated and funded on the Loan Closing Date. Each month, the lender then securitizes the mortgage loans, and either sells or retains the MSR in a similar fashion as described above. Referring now to Fig. 2, loan interest rates from April 1st, 2004 through July 31st, 2004 are illustrated. For illustration of this embodiment, it is assumed that the lender originates 3 loans per day between April 1st, and June 30th, and then sells the MSR asset on July 30th (MSR Sale Date). Loans originated in these months would likely have multiple security issue dates corresponding to the dates of securitization and sale of the loans to the Investor that typically occur monthly as described above.

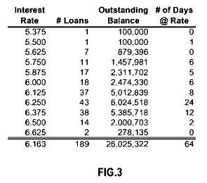

In this example, three loans are produced daily from the beginning of April to the end of June, with each of these three loans per day having a different interest rate. In this example, one loan has an interest rate near the Par rate for the day, the second loan has in interest rate slightly above the Par rate for the day, and the third loan has an interest rate slightly below the Par rate for the day. A summary of the resulting universe of loans available for sale on July 30th is provided in Fig. 3. As of the July 30th MSR Sale Date, the Originator had an aggregate total of 189 loans with an unpaid balance of $26,025,322, and an average aggregate interest rate of 6.163%.

Once loans are closed on the Loan Closing Date, they are pooled together, securitized and the MBS are issued by the Investor. As mentioned above, this process allows the Originators to sell their loans, thereby recouping the loan amount (at a profit) and originate new loans with the proceeds. Generally, in order to issue the security, each loan must meet established underwriting guidelines that are well known and understood in the industry. The process of selling loans begins with the Originator choosing the yield or Pass Through Rate at which the loans will be pooled into. The yields are typically grouped by 50 basis point (bp) increments, while lock-in rates are typically broken into 12.5 bp groups. The difference between the actual borrower interest rate on the loans in the pool and the pass through rate is known as the Gross Servicing Fee. A portion of this Gross Servicing Fee must be remitted to the issuing Agency for a Guarantor Fee. The difference between the Gross Servicing Fee and the Guarantor Fee (after any adjustments) is known as the net servicing fee. The value of mortgage servicing rights is driven by this net servicing fee amount, which equates to the monthly cash flow that the servicer receives for servicing the loan. The MSR asset is created when the securities are issued on the security issue date, because the underlying loan is separated from the servicing of the loan creating two assets.

Under traditional MSR sale transactions, the MSR asset described above would be sold to a potential MSR buyer through a Forward Bulk Sales Structure (Flow Servicing Transaction). The pricing for this transaction is generally set for a term of 3 to 12 months, and is based upon the historic loan production of the lender. In order to set the pricing, the MSR buyer would look at 3 to 6 months worth of the lenders prior production, and set a price for a specific time period in the future. All loans delivered within a given time period would receive the same base price.

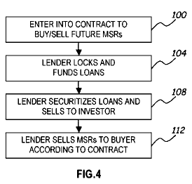

Referring now to the flow chart of Fig. 4, a MSR sale transaction of an embodiment of the present invention is described. Initially, as indicated at block 100, the buyer and seller enter into a contract to buy/sell MSR that the seller will generate through a future time period. The contract to buy/sell, also referred to herein as a Purchase and Sale Agreement, includes a pricing provision that measures Par at the date the MSR asset is sold, and the price of the MSR is based on the difference between the loan interest rate and Par on the date of the MSR sale. At block 104, the lender locks and funds the loan. As described earlier, the loan interest rate may be locked-in prior to the closing date when the loan is funded, and the operations of block 104 are simply a general description of the process for the lender to originate and close a loan, including the loan application, lock-in, and closing. At block 108, the lender securitizes the loans and sells the loans to an Investor. As mentioned above, the time period of the securitization is generally monthly around the middle of a month. Finally, at block 112, the lender sells the MSR to the buyer according to the contract. The price of the MSR is determined, as previously mentioned, according to the difference between the loan interest rate and Par on the MSR Sale Date. The determination of Par, and the contract pricing for loans that have interest rates at or different than Par will be described in further detail below.

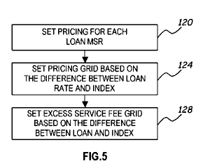

Referring now to Fig. 5, a flow chart diagram illustrating the pricing for MSR according to an embodiment of the invention is now described. At block 120, pricing is set for each MSR to be sold according to the Purchase and Sale Agreement. At block 124, a pricing grid is set based on the difference between the loan interest rate and an index rate (Par) at the time the MSR will be sold. At block 128, an excess service fee grid is set based on the difference between the loan interest rate and an index rate (Par) at the time the MSR will be sold. In this manner, the MSR pricing for each loan made by the lender is priced at the sale of the MSR asset.

Under the MSR sale method of this embodiment, interest rate risks are the responsibility of the seller up until the MSR Sale Date. Every day as the Par interest rates change, the value of the MSR for the universe of loans they have already closed is adjusted according to the market pricing for those assets. At the time of the sale, the seller knows the exact price of the sale, and generally will have been able to place a MSR Hedge to protect themselves from changes in value due to interest rate movements. This allows the buyer of the MSR asset to pay an accurate price for the MSR asset as of the MSR Sale Date. The buyer in this case would not need to place a MSR Hedge to protect themselves prior to acquiring the asset. Instead, the buyer receives the MSR asset at true market value, and is then able to place any appropriate MSR Hedge(s) starting with a true market value.

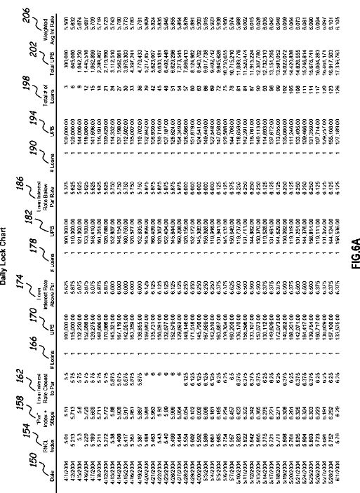

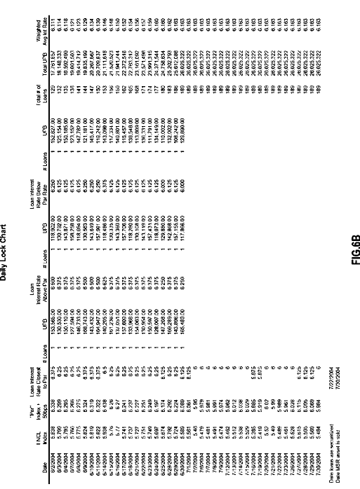

Referring again to the example of Figs. 2 and 3, a daily lock chart for the loans described is illustrated in Figs. 6A and 6B. This daily lock chart illustrates each loan closed during the particular day that would go into one month's securitization. In this example, loans are locked every day from April 1 through June 30th, going into a July securitization. As previously described, there are 3 loans locked each day, and all three loans have a different interest rate. Additionally, as described above, interest rates move every day. In the chart of Fig. 6, several columns of data are present. Column 150 includes date information that is the date that the mortgagor locks in the interest rate on the loan. Column 154 includes financial index information. The financial index information of column 154 may be one of many indexes available that correlates to mortgage interest rates. Generally, the index is the average yield (for securitized bonds) purchased by Fannie Mae on that day. Column 158 includes information for the index plus 50 basis points. This is a calculation of the average interest rate available to a mortgagor, and is referred to as the interest rate index (Par). Columns 162 – 194 show three loans being locked on a particular day. The first loan, columns 166 – 170, is locked in at the nearest 1/8th percent to Par. The second loan, columns 174 – 182 is locked in 1/8 percent above, and the third loan, columns 186 – 194 is locked in 1/8 percent below. In each loan for the particular day, the first column (162, 174, 186) represents the interest rate for the loan, the second column (166, 178, 190) represents the number of loans, and the third column (170, 182, 194) represents the unpaid principle balance (UPB) of the loan. Column 198 represents the total number of loans, column 202 represents the total UPB, and column 206 is the weighted average interest rate.

For this example, the securitization date is July 22, 2004. This is the day that the loans are securitized and the MBS are issued by the Investor. A typical Investor, as mentioned previously, may be Fannie Mae, Freddie Mac or Ginnie Mae. This is the point in time that the Mortgage Servicing Right (MSR) asset is first created. However, the value of the MSR has been at risk since the interest rate on the loan was locked in. On July 30, 2004, the MSR are sold in a co-issue or forward bulk transaction. The total principal balance sold is $26,025,322.

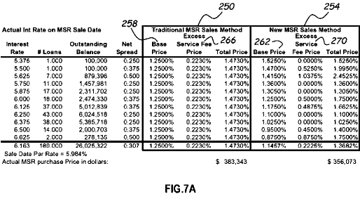

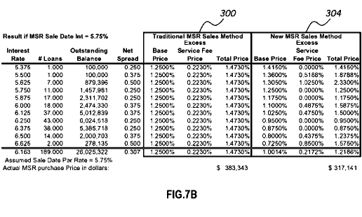

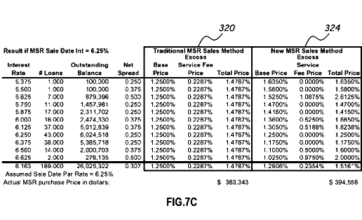

Referring now to Fig. 7A, a table illustrating the amount of product that is sold by interest rate, and pricing of the MSR, is summarized. In the example of Fig. 7A, the interest rate available on the MSR Sale Date, July 30 in this example, is 5.984%. The servicing fee that is created at each interest rate, the net spread, is listed for each interest rate. Twenty-five basis points of servicing fee is considered to be a Base Servicing Fee for Fannie Mae and Freddie Mac fixed-rate loans. Any servicing fee beyond 25 basis points is considered to be Excess Servicing Fee. The chart of Fig. 7A illustrates pricing under the traditional MSR sales method 250, and the new MSR sales method 254. The pricing on both is divided into pricing for the Base Servicing Fee 258, 262, and Excess Servicing Fee 266, 270. Under both methodologies the price for a servicing right with an interest rate of 6% is the same at 1.25%. However, the value of the servicing right sold under the new MSR sales method is affected by interest rates. This does not affect the pricing under the traditional methodology because the buyer has the risk of interest rate fluctuations between the lock date and the MSR Sale Date.

Under the traditional method, the interest rate on the MSR Sale Date is not relevant and all of the servicing rights are priced the same at the aggregate level. Therefore, even though the servicing fee is different on all loans, the pricing is done based upon the aggregate servicing fee of 30.7 basis points. Under the new method, pricing is based upon the difference between the interest rate on the servicing right and Par interest rates on the MSR Sale Date. The buyer pays up or down based upon interest rate movements between the lock date and the MSR Sale Date. In this example, the servicing rights are priced at the interest rate tranche level, but could be priced at the loan level, the interest tranche level or in aggregate. As an example, the 5.375% interest rate tranche has a servicing fee of 25 basis points so there is no price for Excess Servicing Fee in the new method. However, the 5.5% interest rate tranche has a servicing fee of 37.5 basis points so there is a price of 0.525% for the Excess Servicing Fee for this tranche.

As the chart of Fig. 7A indicates, in this example there are numerous interest rates on the servicing rights that are sold on July 30, 2004. The interest rate index on July 30, 2004 is 5.984%. There is approximately $5 million of product with interest rates below Par on this day, approximately $2.5 million of product with interest rates closest to Par, and approximately $18.5 million of product with interest rates above Par on this day.

The actual value of the servicing rights on July 30, 2004 is indicated on this chart. As an example, on 4/1/2004 three loans were created with interest rates of 5.50%, 5.625% and 5.375% respectively. On the MSR Sale Date, the servicing value on all three loans at 25 basis points of servicing fee (Base Servicing Fee) are 1.47%, 1.415% and 1.525% respectively. Under the new MSR sales method, this is the price that the buyer would pay for the Base Servicing Fee. Under the traditional MSR sales method, the price at the Base Servicing Fee was 1.25% for all three loans.

Another example would be to look at loans locked on 6/1/2004. The interest rates of these loans were 6.25%, 6.375% and 6.125% respectively. The servicing value and price under the new method for the Base Servicing Fee are 0.95%, 0.875% and 1.025% respectively. However, with the traditional method the price for the Base Servicing Fee would still be 1.25%.

Referring now to Fig. 7B, a chart illustrates the price that would be paid to the seller under both a traditional MSR sales method 300 the new MSR sales method 304, in the case where the Par interest rate had been 5.75% on the MSR Sale Date. Under the traditional methodology, the price would be unchanged in the same fashion as described above. Under the new methodology, the price would have dropped from 1.4730% to 1.2186%.

Referring now to Fig. 7C, a chart illustrates the price that would be paid to the seller under both a traditional MSR sales method 320 the new MSR sales method 324, in the case where the Par interest rate had been 6.25% on the MSR Sale Date. Under the traditional MSR sales methodology, the price would again be unchanged. Under the new MSR methodology, the price would have increased from 1.4730% to 1.5161%.

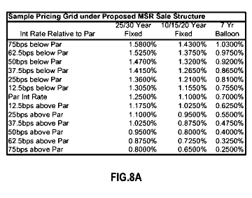

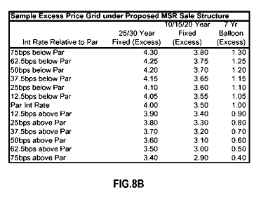

Referring now to Figs. 8A and 8B, a typical pricing grid under the new MSR Sales Structure is illustrated. Figure 8A illustrates an example of the new pricing structure for Base Servicing Fee. As indicated in the chart of Fig. 8A, the price for the Base Servicing Fee for different interest rates and for different mortgage products is adjusted based on the difference between the MSR interest rate and the Par interest rate at the time the MSR is sold. As may be observed, all of the pricing is based upon the difference between the interest rate on the servicing right and the Par interest rate on the MSR Sale Date. Figure 8B illustrates an example of the new pricing structure for the excess service fee. As indicated in Fig. 8B, the excess price according to the new pricing structure is also adjusted based on the difference between the MSR interest rate and the Par interest rate at the time the MSR is sold. As with the Base Servicing Fee of Fig. 8A, the price paid for Excess Servicing Fee (expressed as a multiple of servicing fee) of Fig. 8B is dependent upon the difference between the interest rate on the servicing right and the Par interest rate on the MSR Sale Date.

When determining the pricing grids for a sale of MSR agreed to in a Purchase and Sale Agreement, the buyer and seller must negotiate the base price, changes to the base price resulting from interest rate changes, and the excess price grid. In one embodiment, the Par interest rate is based on a publicly available index of market interest rates that is agreed upon in the Purchase and Sale Agreement. Such a publicly available index may be, for example, MTGEFNCL available daily on Bloomberg. As will be understood, numerous indexes are available for the determination of the Par interest rate on any given day, and for any given loan product such as a conventional 30 year fixed or a conventional 15 year fixed loan or adjustable rate mortgages.

In one embodiment, a broker facilitates the Purchase and Sale Agreement between the buyer and the seller. In this embodiment, the broker may solicit bids from one or both parties for entering into such an agreement, and facilitate the optimal price for the parties. In these embodiments, a broker may take a percentage of the total contract price as payment. The broker may also collect a fixed fee, or have any other compensation scheme that is deemed appropriate.

While the invention has been particularly shown and described with reference to a preferred embodiment thereof, it will be understood by those skilled in the art that various other changes in the form and details may be made without departing from the spirit and scope of the invention.

1. A method for setting a price for at least one mortgage servicing right (MSR), comprising:
setting a contract price for at least one MSR associated with at least one mortgage loan, said at least one mortgage loan originated by a lender, the mortgage loan having a loan interest rate;
determining a par interest rate for a date on which said first MSR will be sold from said lender to a buyer of said first MSR; and
adjusting a price paid for said MSR by said buyer based on a difference between said loan interest rate and said par interest rate.

2. The method for setting a price for at least one MSR, as claimed in claim 1, wherein said setting step comprises:
setting a price for each MSR to be sold; and
setting a price adjustment for a rate difference between said par interest rate and said loan interest rate.

3. The method for setting a price for at least one MSR, as claimed in claim 1, wherein said determining step comprises:
accessing a publicly available index of market interest rates.

4. The method for setting a price for at least one MSR, as claimed in claim 3, wherein said publicly available index is MTGEFNCL that is available daily on Bloomberg.

5. The method for setting a price for at least one MSR, as claimed in claim 1, wherein said adjusting step comprises:
calculating a difference between said loan interest rate and said par interest rate; and
adjusting said price based on a magnitude of said difference.

6. The method for setting a price for at least one MSR, as claimed in claim 1, wherein said adjusting step comprises:
calculating a difference between said loan interest rate and said par interest rate;
setting a pricing grid comprising adjustment factors for a base price and an excess multiple based on a difference between the loan interest rate and said par interest rate; and
determining a modified price based on said pricing grid and said difference between said loan interest rate and said par interest rate.

7. The method, as claimed in claim 6, wherein said price for said MSR comprises a price for a base servicing fee and excess servicing fee.

8. The method, as claimed in claim 6, wherein said determining step comprises:
accessing a publicly available index of market interest rates to determine said par interest rate;
calculating a difference between said loan interest rate and said par interest rate as of the MSR sale date; and
determining said final price based on said difference and said pricing grid.

9. A method for valuing a mortgage servicing right (MSR) to be sold by a seller to a buyer at a future MSR sale date, comprising
setting a contract price for at least one MSR associated with at least one mortgage loan, said at least one mortgage loan to be originated by said seller at a future closing date and said at least one mortgage loan having an associated loan term and loan interest rate; and
setting a pricing grid for determining a final price for said at least one MSR based on said contract price and a difference between said loan interest rate and a market interest rate on said future MSR sale date.

10. The method, as claimed in claim 9, wherein said setting a contract price comprises:
analyzing a plurality of prior loans originated by said seller over a predetermined time period prior to said setting step;
accounting for future interest rate movements; and
setting said contract price based upon actual interest rates of said loans and the impact of future par interest rate movements.

11. The method, as claimed in claim 9, wherein said pricing grid comprises:
a par interest rate corresponding to a market interest rate on said future MSR Sale date; and
a plurality of bands corresponding to a magnitude of said difference between said loan interest rate and said par interest rate on said future MSR sale date.

12. The method, as claimed in claim 9, wherein said final price is greater than said contract price when said par interest rate is greater than said loan interest rate.

13. The method, as claimed in claim 9, wherein said final price is less than said contract price when said market interest rate is less than said loan interest rate.

14. A contract for the purchase and sale of at least one mortgage servicing right (MSR) associated with at least one mortgage loan that is closed on a mortgage closing date and has a loan interest rate, comprising:
an execution date that is the date that a buyer and a seller execute the contract, said execution date being before or after said mortgage closing date;
a sale date that is the date on which said MSR will be sold to the buyer, said sale date being after said mortgage closing date, wherein said buyer assumes risk of changes in MSR value occurring subsequent to said sale date; and
a sale price;
wherein said sale price is determined on said sale date, and wherein a valuation difference caused by interest rate changes relative to said loan interest rate between a closing MSR value on said mortgage closing date and a sale MSR value on said sale date is assumed by said seller.

15. The contract, as claimed in claim 14, wherein said sale price is determined according to the following steps:
determining a par interest rate for said sale date; and
adjusting said sale price based on a difference between said loan interest rate and said par interest rate.

16. The contract, as claimed in claim 15, wherein said adjusting step comprises:
calculating a difference between said loan interest rate and said par interest rate;
setting a pricing grid comprising adjustment factors for a base price and an excess multiple based on a difference between said loan interest rate and said par interest rate; and
determining said sale price based on said pricing grid and said difference between said loan interest rate and said par interest rate.

17. The contract, as claimed in claim 15, wherein said determining step comprises:
accessing a publicly available index of market interest rates; and
determining said par interest rate based on said index.

18. The contract, as claimed in claim 17, wherein said publicly available index is MTGEFNCL that is available daily on Bloomberg.
